(19) United States
(12) Patent Application Publication
(10) Pub. No.: US 2014/0089178 A1
(43) Pub. Date: Mar. 27, 2014

(54) MOBILE FINANCIAL TRANSACTION SYSTEM AND METHOD

(71) Applicant: GOTrust Technology Inc., Taichung City (TW)

(72) Inventors: Tien Chi Lee, Taichung City (TW); Jeng Lung Li, Taichung City (TW); Chun Wei Tsai, Taichung City (TW)

(73) Assignee: GOTrust Technology Inc., Taichung City (TW)

(21) Appl. No.: 14/023,680

(22) Filed: Sep. 11, 2013

(30) Foreign Application Priority Data
Sep. 21, 2012 (TW) 101134777

(51) Int. Cl. G06Q 20/32

(52) U.S. Cl. CPC G06Q 20/3223
USPC 705/40

(57) ABSTRACT

Mobile financial transaction system and method are disclosed for use with mobile payment and secure financial service platform. With the method and system disclosed, users can perform mobile financial transactions with a handheld mobile device. First, a billing information is acquired through the Internet and/or image capturing, and then a microSD flash memory card embedded with security chip and containing a personal financial information and/or near field communication technology is used to communicate with nearby payment devices to acquire a payment information. The payment information is then transferred to a payment gateway to finish a financial transaction. In addition, a secure value added service platform provides follow-up financial services.

### CROSS-REFERENCES TO RELATED APPLICATIONS

This application claims the priority of Taiwanese Patent application No. 101134777, filed on Sep. 21, 2012, which is incorporated herewith by reference.

### BACKGROUND OF THE INVENTION

1. Field of the Invention

The present invention relates to a financial transaction system and method, more particularly to a financial transaction system and method for use with mobile payment and secures financial service platform environments. The system and method can provide secure and convenient mobile finance and value added services.

2. The Prior Arts

In the current mobile financial services, users can access the services provided by online banking with their personal computers, laptops, and tablet computers through internet services. However, this kind of mobile financial service has a drawback due to internet security, which can expose user's account under the risks of being stolen.

On the other hand, the mobile financial services on the cell phones nowadays can only inform the user about the information of the transaction amount and content through SMS after a transaction is made with credit card. The reason that the cell phone does not provide other mobile financial services is because the financial messages being transferred are not encrypted, therefore, the messages transferred between the cell phone and mobile financial service end are not completely secure.

In addition, as the mobile communication technology and the wireless data transmission rate grow, the mobile communication devices or mobile phones also become more prevalent. Mobile communication devices or mobile phones have become a tool of mobile payment, for example, users can browse on the online shops on the screen and make purchases on the devices. As for the payment methods, the micro-payment system provided by the carriers, ATM transfers or simply entering the credit card number on the webpage are still the most used methods. Nevertheless, the abovementioned payment methods are either insecure or inconvenient; therefore, mobile shopping and its payment methods still have the room of improvements.

In short, developers are still looking for a mobile financial transaction system and method, which provide secure and convenient mobile shopping and payment method. Such system and method should be able to provide financial value added service, and also provide encrypted confirmation messages after a financial transaction is completed.

### SUMMARY OF THE INVENTION

The primary objective of the present invention is to provide a mobile financial transaction system and method for use with mobile payment and secure financial service platform environments. When performing mobile financial transaction services, the system and method can provide secure and convenient mobile shopping and payment method, and financial value added service. After the transaction is completed, the method and the system can provide encrypted confirmation messages in a secure way.

Another objective of the present invention is to provide a mobile financial transaction system and method for use with mobile payment and secure financial platform environments, where a microSD flash memory card embedded with a security chip and containing a personal financial information and/or near field communication (NFC) technology is used to sense a nearby payment device. In addition, a payment gateway and secure value added service provides follow-up financial services, so that the secure and convenient mobile payment mechanism and financial value added service can be achieved.

Another objective of the present invention is to provide a mobile financial transaction system and method for use with mobile payment and secure financial platform environments, where the method and system combine the microSD flash memory card embedded with a security chip containing a personal financial information with NFC technology and/or image capturing. In addition, a payment gateway and secure value added service provides follow-up financial services, so the secure and convenient mobile payment mechanism and financial value added service can be achieved.

Based on the purposes described above, the present invention provides a mobile financial transaction system, where the system at least includes a microSD flash memory card embedded with a security chip containing a personal financial information, a payment gateway and a secure value added service platform. The microSD flash memory card is integrated in a handheld mobile communication device, such as android phone, iPhone, tablet computer and iPad.

A mobile payment application (app) is stored in the microSD flash memory card described above, which is integrated in the handheld mobile communication device (e.g. android phones, iPhone, tablet PC and iPad). The mobile payment app can acquire billing information through the Internet and/or image capturing of the handheld communication devices first, and then generates a payment information accordingly. Alternatively, the payment app can also acquire a billing information by sensing nearby payment devices with the microSD flash memory card embedded with a security chip containing a personal financial information and/or NFC technology, and then generates a payment information accordingly. The payment information generated is then transfer to the payment gateway.

The payment gateway can be located at the cash flow end as the payment mechanism. When the payment information is received by the payment gateway, the payment gateway connects with the bank system to finish the financial transaction.

The bank system transmits the transaction messages to the secure value added service platform after the financial transaction is completed. The secure value added service platform then provides follow-up financial services to achieve secure and convenient mobile payment method and financial value added service. The follow-up financial services herein include sending transaction messages/SMS to the handheld mobile devices after finishing the financial transactions, and/or sending the billing statement to the handheld mobile device in the form of message/SMS on a regular or irregular basis.

Hereafter, the mobile financial transaction method using the mobile financial transaction system of the present invention is described. First, users can acquire the billing information by operating the mobile payment app on the handheld mobile communication device via the Internet and/or image capturing. Next, after acquiring the billing information, the mobile payment app generates payment information by sensing nearby payment device with the microSD flash memory card embedded with a security chip and containing personal financial information and/or NFC technology. The payment information is then transferred to the payment gateway. After the payment gateway receives the payment information, the payment gateway is connected to the bank system to complete the financial transaction. Further, when the financial transaction is completed, the bank system transmits the transaction message to the secure value added service platform connected, and then the secure value added service platform provides the follow-up financial services to achieve secure and convenient mobile payment mechanism and financial value added service. Herein, the follow-up financial services include sending transaction messages/SMS to the handheld mobile devices, which completed financial transactions, and/or sending the billing statement to the handheld mobile device in the form of message/SMS on a regular or irregular basis to inform the users.

### BRIEF DESCRIPTION OF THE DRAWINGS

FIG. 1 is a schematic view showing the configuration and operation of the mobile financial transaction system of the present invention;

FIG. 2 is a flow chart showing the steps of the mobile financial transaction method of the system in FIG. 1;

FIG. 3 is a schematic view showing the configuration and operation of an embodiment of the mobile financial transaction system of the present invention;

FIG. 4 is a flow chart showing the steps of an embodiment of the mobile financial transaction method of the system in FIG. 3;

FIG. 5 is a schematic view showing the configuration and operation of another embodiment of the mobile financial transaction system of the present invention; and

FIG. 6 is a flow chart showing the steps of an embodiment of the mobile financial transaction method of the system in FIG. 5.

### DETAILED DESCRIPTION OF THE PREFERRED EMBODIMENTS

The present invention will be apparent to those skilled in the art by reading the following detailed description of preferred embodiments thereof, with reference to the attached drawings.

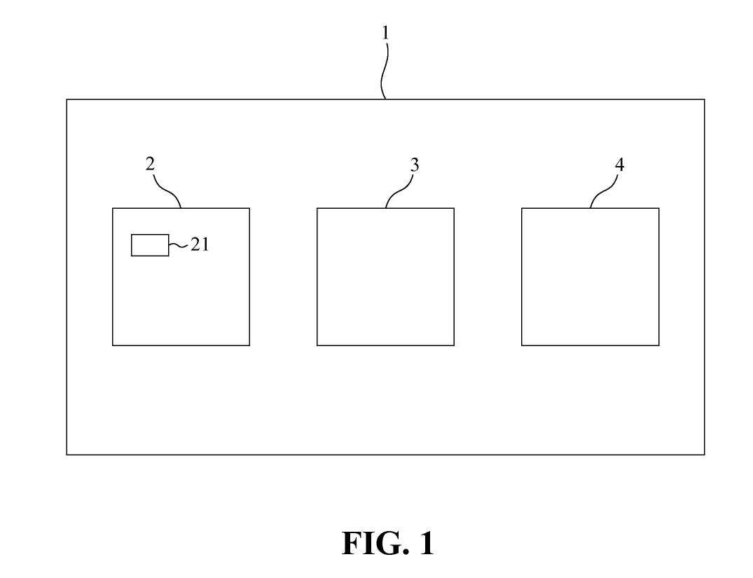

FIG. 1 is a schematic view showing the configuration and operation of the mobile financial transaction system of the present invention. As shown in FIG. 1, the mobile financial transaction system 1 at least includes a microSD flash memory card 2 embedded with a security chip containing a personal financial information, a payment gateway 3 and a secure value added service platform 4. The microSD flash memory card 2 is located in a handheld mobile communication device (not shown in the graph, e.g. android phones, iPhone, tablet PC and iPad).

A mobile payment app 21 is stored in the microSD flash memory card 2 described above. After the mobile payment app 21 acquires a billing information (not visible) via the Internet (not visible) and/or image capturing (not visible) of the handheld mobile communication device, a payment information (not visible) is generated with the microSD flash memory card 2 via NFC technology. The handheld mobile communication device then transmits the payment information to the payment gateway 3 through wireless communication.

The payment gateway 3 can be located at the cash flow end (not visible) as the payment mechanism. After receiving the payment information, the payment gateway 3 connects to the bank system (not visible) to finish the financial transaction.

The bank system transmits the transaction messages (not visible) to the secure value added service platform 4 after the financial transaction is completed. The secure value added service platform 4 then provides follow-up financial services to achieve secure and convenient mobile payment method and financial value added service. The follow-up financial services herein include sending encrypted transaction messages/SMS (not visible) to the handheld mobile devices that completed transactions, and/or sending the billing statement to the handheld mobile device in the form of message/SMS on a regular or irregular basis.

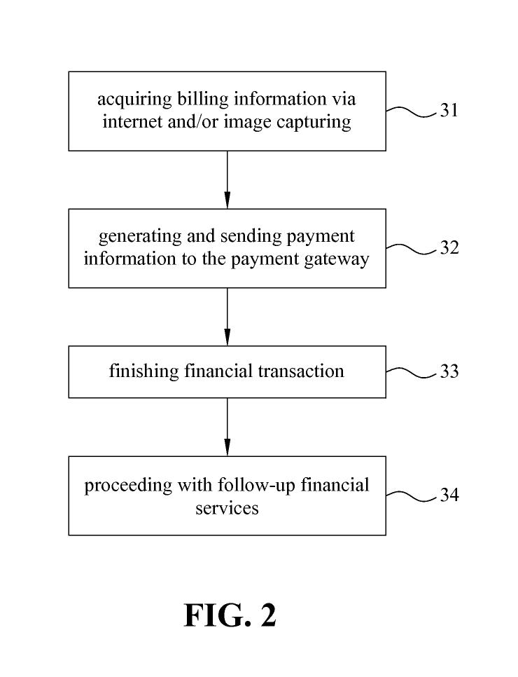

FIG. 2 is a flow chart showing the steps of the mobile financial transaction method of the system in FIG. 1. As shown in FIG. 2, the first step is step 31, where the billing information is acquired through the Internet and/or image capturing. The users can operate the handheld mobile communication device in such way that the mobile payment app can retrieve billing information through the Internet and/or image capturing of the handheld mobile communication device. After the billing information is retrieved, step 32 can be continued.

In step 32, a payment information is generated and is sent to the payment gateway. After acquiring the billing information, the mobile payment app generates the payment information by sensing nearby payment device with the microSD flash memory card embedded with security chip and containing a personal financial information via NFC technology. The handheld mobile communication device then transmits the payment information to the payment gateway through wireless communication. After payment information is transmitted, step 33 can be continued. Herein, the sensing nearby payment devices and generating the billing information via the NFC technology, indicates that the mobile devices with NFC function reads from the indirect contact type or induction type debit card, credit card, transportation card and/or any other IC cards with indirect contact payment function to generate the financial information.

In step 33, the payment gateway is connected to the bank system to finish the financial transaction after receiving the payment information. After the transaction is completed, step 34 can be continued.

In step 34, the secure value added service platform provides the follow-up financial services after the financial transaction is completed. The bank system sends transaction messages to the secure value added service platform connected therewith, so that the secure value added service platform provide the follow-up financial services to achieve secure and convenient mobile payment method and financial value added service. Herein, the follow-up financial services include sending transaction messages/SMS to the handheld mobile devices, which completed financial transactions, and/or sending the billing statement to the handheld mobile device in the form of message/SMS on a regular or irregular basis to inform the users.

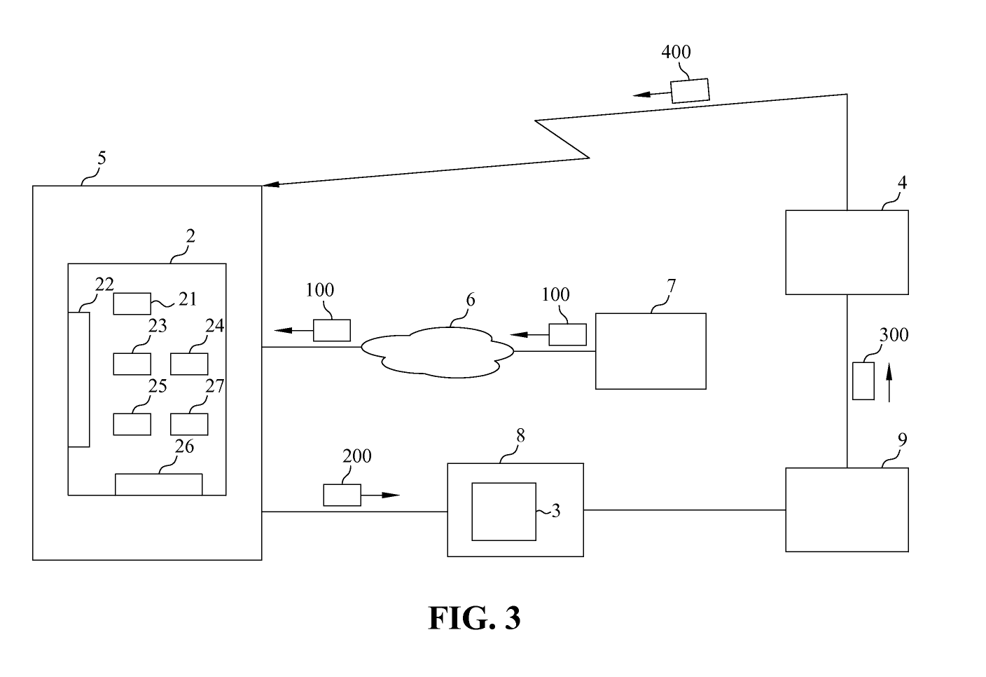

FIG. 3 is a schematic view showing the configuration and operation of an embodiment of the mobile financial transaction system of the present invention. As shown in FIG. 3, the mobile financial transaction system 1 at least includes a microSD flash memory card 2 embedded with a security chip containing a personal financial information, a payment gateway 3 and a secure value added service platform 4. The microSD flash memory card 2 is located in a handheld mobile communication device 5 such as android phones. The microSD flash memory card 2 at least includes a mobile payment app 21, and can also include memory card interface 22, control chip 23, flash memory module 24, security control chip 25, microSD interface 26 and personal financial information 27. In such way, when the microSD flash memory card 2 is installed in the handheld mobile communication device, it can provide other corresponding services according to the need of the user.

After the mobile payment app 21 in the microSD flash memory card 2 acquires the billing information 100 through the wireless internet 6 of the handheld mobile communication device 5, it generates and transmits the payment information 200 to the payment gateway 3 through wireless communication of handheld mobile communication device 5. The user can shop on the webpage (not visible) shown on the screen (not visible) of the handheld mobile communication device 5, and/or on a shopping app (not visible) for desirable merchandizes (not visible). After the user finishes shopping, the website 7 connected with the webpage or the shopping app generates corresponding billing information, which is transmitted to the handheld mobile communication device through wireless internet 6.

The payment gateway 3 can be located at the cash flow end 8 as the payment mechanism. After receiving the payment information 200, the payment gateway 3 is connected to the bank system 9 to finish the financial transaction.

The bank system 9 transmits the transaction messages 300 to the secure value added service platform 4 after the financial transaction is completed. The secure value added service platform 4 then provides follow-up financial services to achieve secure and convenient mobile payment method and financial value added service. The follow-up financial services herein include sending encrypted transaction messages/SMS 400 to the handheld mobile devices 5 that completed transactions to inform the user about the completion of the transaction.

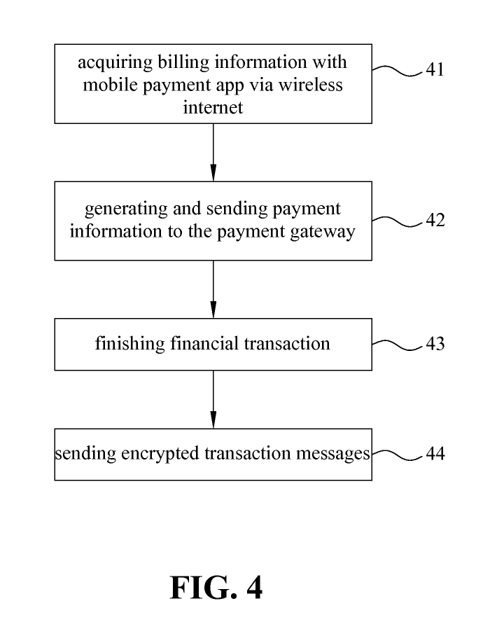

FIG. 4 is a flow chart showing the steps of an embodiment of the mobile financial transaction method of the system in FIG. 3. As shown in FIG. 4, the first step is step 41, where the billing information 100 is acquired through wireless internet 6. The user can operate the handheld mobile communication device 5 in such way that the mobile payment app 21 can retrieve the billing information 100 through the wireless internet 6 of the handheld mobile communication device 5. After the billing information 100 is retrieved, step 42 can be continued.

In step 42, the payment information 200 is generated and transmitted to payment gateway 3. After the billing information 100 is retrieved, mobile payment app 21 generates the payment information 200, which is transmitted to the payment gateway 3 through wireless communication of the handheld mobile communication device 5. After the payment information 100 is transmitted, step 43 can be continued.

In step 43, the payment gateway 3 is connected to the bank system 9 after receiving payment information 200 to finish the financial transaction. After the transaction is completed, step 44 can be continued.

In step 44, the secure value added service platform 4 proceeds with follow-up financial services after the financial transaction is completed. The bank system 9 transmits the transaction messages 300 to the secure value added service platform 4 after the financial transaction is completed. The secure value added service platform 4 then provides follow-up financial services to achieve secure and convenient mobile payment method and financial value added service. The follow-up financial services herein include sending encrypted transaction messages/SMS 400 to the handheld mobile devices 5 that completed transactions to inform the user about the completion of the transaction.

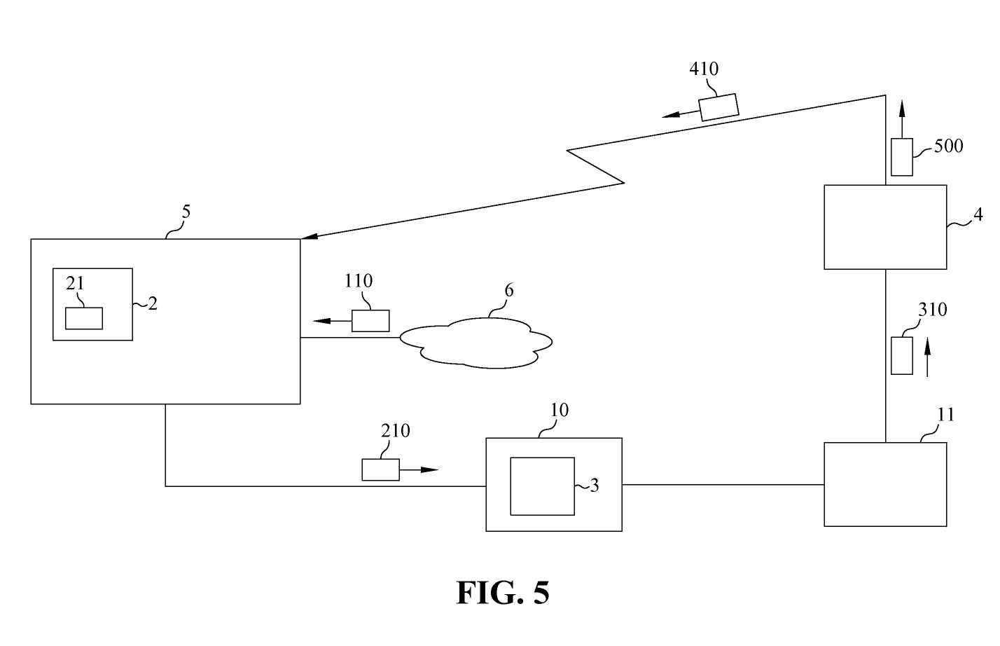

FIG. 5 is a schematic view showing the configuration and operation of another embodiment of the mobile financial transaction system of the present invention. As shown in FIG. 5, the mobile financial transaction system 1 at least includes a microSD flash memory card 2 embedded with a security chip containing a personal financial information, a payment gateway 3 and a secure value added service platform 4. The microSD flash memory card 2 is located in a handheld mobile communication device 5 such as a tablet computer.

A mobile payment app 21 is stored in the microSD flash memory card 2. After the mobile payment app 21 acquires the billing information 110 through the wireless internet 6 and image capturing of the handheld mobile communication device 5, the payment information 210 is generated by sensing nearby payment devices with microSD flash memory card 2 and/or NFC technology. With the wireless communication of the handheld mobile communication device, the payment information 210 is then transmitted to the payment gateway 3. Herein, the user captures the image of a barcode containing billing information with the camera (not visible) of the handheld mobile communication device 5 to generate the billing information 110.

The payment gateway 3 can be located at the cash flow end 8 and can be a NFC payment mechanism. After receiving the payment information 210, the payment gateway 3 is connected to the bank system 11 to finish the financial transaction.

The bank system 11 transmits the transaction messages 310 to the secure value added service platform 4 provided after the financial transaction is complete. The secure value added service platform 4 then provides follow-up financial services to achieve secure and convenient mobile payment method and financial value added service. The follow-up financial services herein include sending encrypted transaction messages/SMS 410 to the handheld mobile devices 5 that completed transactions, and/or sending the encrypted billing statement 500 to the handheld mobile device 5 in the form of message/SMS.

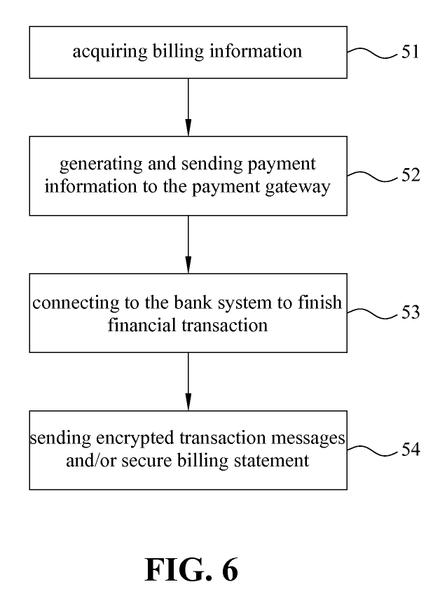

FIG. 6 is a flow chart showing the steps of an embodiment of the mobile financial transaction method of the system in FIG. 5. As shown in FIG. 6, the first step is step 51, where the billing information 110 is acquired through wireless internet 6. The user can operate the handheld mobile communication device 5 in such way that the mobile payment app 21 can retrieve the billing information 110 through the wireless internet 6 of the handheld mobile communication device 5. After the billing information 110 is retrieved, step 52 can be continued.

In step 52, the payment information 210 is generated and transmitted to payment gateway 3. After the billing information 110 is retrieved, mobile payment app 21 generates the payment information 210 with the mircroSD flash memory card 2 and/or NFC technology, and the payment information 210 is transmitted to the payment gateway 3 through wireless communication of the handheld mobile communication device 5. After payment information 210 is transmitted, step 53 can be continued.

In step 53, the payment gateway 3 is connected to the bank system 11 after receiving payment information 210 to finish the financial transaction. After the transaction is completed, step 54 can be continued.

In step 54, the secure value added service platform 4 proceeds with follow-up financial services after the financial transaction is completed. The bank system 11 transmits the transaction messages 310 to the secure value added service platform 4 after the financial transaction is completed. The secure value added service platform 4 then provides follow-up financial services to achieve secure and convenient mobile payment method and financial value added service. The follow-up financial services herein include sending encrypted transaction messages/SMS 410 to the handheld mobile devices 5 that completed transactions, and/or sending the encrypted billing statement 500 to the handheld mobile device 5 in the form of message/SMS.

With the embodiments described above, the present invention provides a mobile financial transaction system and method for use with mobile payment and secure financial service platform environment. With the method and system disclosed, users can perform mobile financial transactions with a handheld mobile device. First, the billing information is acquired through the Internet and/or image capturing, and then a microSD flash memory card embedded with a security chip and containing a personal financial information and/or near field communication technology is used to communicate with nearby payment devices to acquire payment information. The payment information is then transferred to a payment gateway to finish the financial transaction. In addition, follow-up financial services provided by the secure value added service platform can be performed to achieve secure and convenient mobile mechanism and financial value added service. The method and system provided by the present invention have the following advantages:

(i) When performing mobile financial transaction services, the present invention provides secure and convenient mobile shopping and payment method, along with financial value added service. After the financial transaction is completed, the user will be notified with secure encrypted message.

(ii) The present invention utilizes the microSD flash memory card embedded with a security chip and the NFC technology which are easy to install and use. In addition, the follow-up financial services provided by the secure value added service platform helps to achieve the secure and convenient mobile payment mechanism and financial value added service.

(iii) The present invention combines the microSD flash memory card embedded with a security chip and containing a personal financial information with NFC technology and image capturing. In addition, with payment gateway and secure value added service platform, the secure and convenient mobile payment mechanism and financial value added service can be achieved, the internet security of mobile financial services can be improved and the risk of user's account being stolen can be avoided.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A mobile financial transaction method for use in mobile payment and secure financial service platform environments, comprising the following steps:
acquiring a billing information on a handheld mobile device through wireless internet and/or image capturing;
generating a payment information after acquiring said billing information, and then transferring a payment information to a payment gateway;
connecting said payment gateway to a bank system after said payment information is acquired by said payment gateway in order to finish a financial transaction; and
proceeding with a follow-up financial service provided by a secure value added service platform when said financial transaction is finished.

2. The mobile financial transaction method as claimed in claim 1, wherein said follow-up financial service provided by said secure value added service platform includes (i) sending an encrypted transaction messages or SMS to said handheld mobile device to inform finishing of said financial transaction; and/or (ii) sending a billing statement to said handheld mobile device in form of said encrypted transaction message or SMS on a regular or irregular basis.

3. A mobile financial transaction method for use in mobile payment and secure financial service platform, comprising the following steps:
acquiring a billing information with a payment application (app) of a handheld mobile device through wireless internet and/or image capturing thereof, wherein said payment app is stored in a microSD flash memory card embedded with a security chip containing a personal financial information;
generating payment information with the microSD flash memory card containing said personal financial information and embedded with said security chip and/or near field communication (NFC) technology by sensing the payment device nearby after acquiring the billing information, and then sending the payment information to a payment gateway;
connecting said payment gateway to a bank system after said payment information is received by said payment gateway in order to finish a financial transaction; and
sending a transaction message from said bank system to the secure financial service platform connected therewith, and then providing a follow-up mobile financial service of a secure value added service platform.

4. The mobile financial transaction method as claimed in claim 3, wherein the microSD flash memory card embedded with a security chip and containing personal financial information includes at least one of the following: memory card interface, control chip, flash memory module, security control chip, microSD interface and personal financial information.

5. The mobile financial transaction method as claimed in claim 3, wherein said sensing nearby payment device and generating said billing information with NFC technology, indicates that the mobile devices with NFC function reads from an indirect contact type or induction type debit card, credit card, transportation card and/or any other IC cards with indirect contact payment function to generate said financial information.

6. The mobile financial transaction method as claimed in claim 3, wherein said follow-up financial service provided by the secure value added service platform includes (i) sending an encrypted transaction messages or SMS to the handheld mobile device to inform finishing of said financial transaction, and/or (ii) sending said billing statement to the handheld mobile device in form of message or SMS on a regular or irregular basis.

7. The mobile financial transaction method as claimed in claim 4, wherein said follow-up financial service provided by the secure value added service platform includes (i) sending an encrypted transaction messages or SMS to the handheld mobile device to inform finishing of said financial transaction, and/or (ii) sending said billing statement to the handheld mobile device in form of message or SMS on a regular or irregular basis.

8. The mobile financial transaction method as claimed in claim 5, wherein said follow-up financial service provided by the secure value added service platform includes (i) sending an encrypted transaction messages or SMS to the handheld mobile device to inform finishing of said financial transaction, and/or (ii) sending said billing statement to the handheld mobile device in form of message or SMS on a regular or irregular basis.

9. A mobile financial transaction system, for use of mobile payment and secure financial service platforms, comprising:
a microSD flash memory card embedded with a security chip containing a personal financial information, which is integrated with a handheld mobile device, a mobile payment app thereof acquires a billing information through wireless internet and/or image capturing with said handheld mobile device, after acquiring the billing information, said mobile payment app generates a payment information with said microSD flash memory card and/or NFC by sensing a sensing a nearby payment device, and then said mobile payment app transfer said payment information through said handheld mobile device via wireless communication;
a payment gateway which connects with a bank system after receiving said payment information to finish a financial transaction; and
a secure value added service platform connected to said bank system so that said bank system transfers a transaction message to said secure value added service platform, which, in turn, provides follow-up mobile financial services.

10. The mobile financial transaction system as claimed in claim 9, wherein said follow-up financial services provided by said secure value added service platform includes (i) sending an encrypted transaction messages or SMS to said handheld mobile device to inform finishing of said financial transaction; and/or (ii) sending said billing statement to said handheld mobile device in form of message or SMS on a regular or irregular basis.

11. The mobile financial transaction system as claimed in claim 9, wherein said microSD flash memory card embedded with a security chip and containing a personal financial information includes at least one of the following: memory card interface, control chip, flash memory module, security control chip, microSD interface and personal financial information.

12. The mobile financial transaction system as claimed in claim 10, wherein said microSD flash memory card embedded with a security chip and containing a personal financial information includes at least one of the following: memory card interface, control chip, flash memory module, security control chip, microSD interface and personal financial information.

13. The mobile financial transaction system as claimed in claim 9, wherein said payment gateway is a payment mechanism at a cash flow end, and said handheld mobile device is a smart phone or a tablet computer.

14. The mobile financial transaction system as claimed in claim 10, wherein said payment gateway is a payment mechanism at a cash flow end, and said handheld mobile device is a smart phone or a tablet computer.

15. The mobile financial transaction system as claimed in claim 9, wherein said payment gateway is at said cash flow end and is a NFC payment mechanism, said handheld mobile device is a smart phone or a tablet computer with NFC function.

16. The mobile financial transaction system as claimed in claim 10, wherein said payment gateway is at said cash flow end and is a NFC payment mechanism, said handheld mobile device is a smart phone or a tablet computer with NFC function.
